(19) United States
(12) Patent Application Publication
(10) Pub. No.: US 2011/0051020 A1
(43) Pub. Date: Mar. 3, 2011

(54) Video Projector And Image Display System

(75) Inventors: Kazunori KOTANI, Nara-shi (JP); Shigeyuki Hashizume, Shijonawate-shi (JP); Hirofumi Kazumori, Kizugawa-shi (JP); Yukihiro Ohwaki, Daito-shi (JP)

(73) Assignee: Sanyo Electric Co., Ltd., Osaka (JP)

(21) Appl. No.: 12/861,174

(22) Filed: Aug. 23, 2010

(30) Foreign Application Priority Data
Aug. 28, 2009 (JP) 2009-199042

(51) Int. Cl. H04N 9/31

(52) U.S. Cl. 348/744; 348/E09.025

(57) ABSTRACT

A video projector including a plurality of light sources used to display an image and a control unit that switches each of the light sources between states of activation and deactivation. The control unit is capable of setting an activation period for each activation of at least one of the light sources.

### CROSS-REFERENCE TO RELATED APPLICATIONS

This application is based upon and claims the benefit of priority from prior Japanese Patent Application No. 2009-199042, filed on Aug. 28, 2009, the entire contents of which are incorporated herein by reference.

### BACKGROUND OF THE INVENTION

The present invention relates to a video projector including a plurality of light sources used to display pictures and an image display system including such a video projector.

One type of a video projector that projects and displays an image includes a plurality of light sources. For example, when a projector includes two lamps serving as light sources for displaying images, the projector switches the activated one of the two lamps so that the video projector may be used over a long period of time.

Japanese Laid-Open Patent Publication No. 2006-39329 describes a video projector that allows the activation period for each of a plurality of light sources to be set. To prolong the life of the light sources without averaging the cumulative activation time of the light sources, the publication describes setting the activation period of a first light source to eleven hours and the activation period of a second light source to one hour. The light sources are alternately activated in a constant pattern in accordance with the activation period settings.

Digital signage using an image display device, which is an electronic device, is a form for displaying advertisements or the like in commercial and public facilities, such as shopping malls and movie theaters. Generally, digital signage sequentially presents an audience with a plurality of video contents (e.g., product advertisement or o facility introduction). Video contents presented in such a manner have different time lengths. For example, one video content may run over thirty minutes while another video content runs over one hour.

A video projector that displays an enlarged and projected image may be effective when used for the digital signage described above. Particularly, the video projector described above that uses a plurality of light sources may be effective when used for digital signage that requires a video image to be displayed over a long time period.

However, in the prior art device, time may be necessary to switch the light sources. Further, in a projection display device such as that described in the above publication, the light sources are switched in a fixed pattern when the video contents are being presented. When the light sources are switched during the presentation of video content, the video content cannot be displayed during the switching. As a result, the video content would be interrupted when switching the light sources.

### SUMMARY OF THE INVENTION

The present invention provides a video projector and an image display system that present video contents without any interruptions when switching light sources.

One aspect of the present invention is a video projector including a plurality of light sources used to display an image and a control unit that switches each of the light sources between states of activation and deactivation. The control unit is capable of setting an activation period for each activation of at least one of the light sources.

A further aspect of the present invention is a video projector including a plurality of light sources used to display an image and a control unit that switches each of the light sources between states of activation and deactivation. The control unit sets an activation period for each of the light sources in accordance with a reproduction period of the displayed image.

Another aspect of the present invention is an image display system provided with a video projector including a plurality of light sources used to project and display an image and a controller that controls the video projector so as to switch each of the light sources between states of activation and deactivation in accordance with the displayed image.

Other aspects and advantages of the invention will become apparent from the following description, taken in conjunction with the accompanying drawings, illustrating by way of example the principles of the invention.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale. In the drawings, like numerals are used for like elements throughout:

FIG. 1 is a schematic block diagram of an image display system according to a first embodiment;

FIG. 2 is a schematic block diagram of a computer shown in FIG. 1;

FIG. 3 is a schematic block diagram of the projector shown in FIG. 1;

FIG. 4 is a schematic block diagram of a lamp unit of the projector shown in FIG. 3;

FIG. 5 is a schematic flowchart of a setting process for an activation program executed by the projector;

FIG. 6 is a table showing one example of a program list including a lamp activation pattern;

FIG. 7 is a schematic flowchart of a setting process for a repeat pattern performed by the projector;

FIG. 8 is a table showing one example of a repeat list including a repeat pattern;

FIG. 9 is a schematic flowchart of a lamp switching control executed by the projector in the first embodiment;

FIG. 10 is a schematic flowchart of a repeating process executed during the lamp switching control shown in FIG. 9;

FIG. 11 is a schematic block diagram of an image display system according to a second embodiment;

FIG. 12 is a schematic block diagram of a vide reproduction device shown in FIG. 11;

FIG. 13 is a schematic flowchart of a control program in a remote control mode executed by a computer in the second embodiment;

FIG. 14 is a table showing one example of a program list generated by the control program of FIG. 13;

FIG. 15 is a schematic flowchart of a setting process for an activation program executed by the projector in the second embodiment;

FIG. 16 is a table showing one example of a program list stored in a memory of the projector;

FIG. 17 is a schematic flowchart of the operation of the video reproduction device that outputs a video signal in the second embodiment; and

FIG. 18 is a schematic flowchart of a lamp switching control executed by the projector in the second embodiment.

### DETAILED DESCRIPTION OF THE INVENTION

### First Embodiment

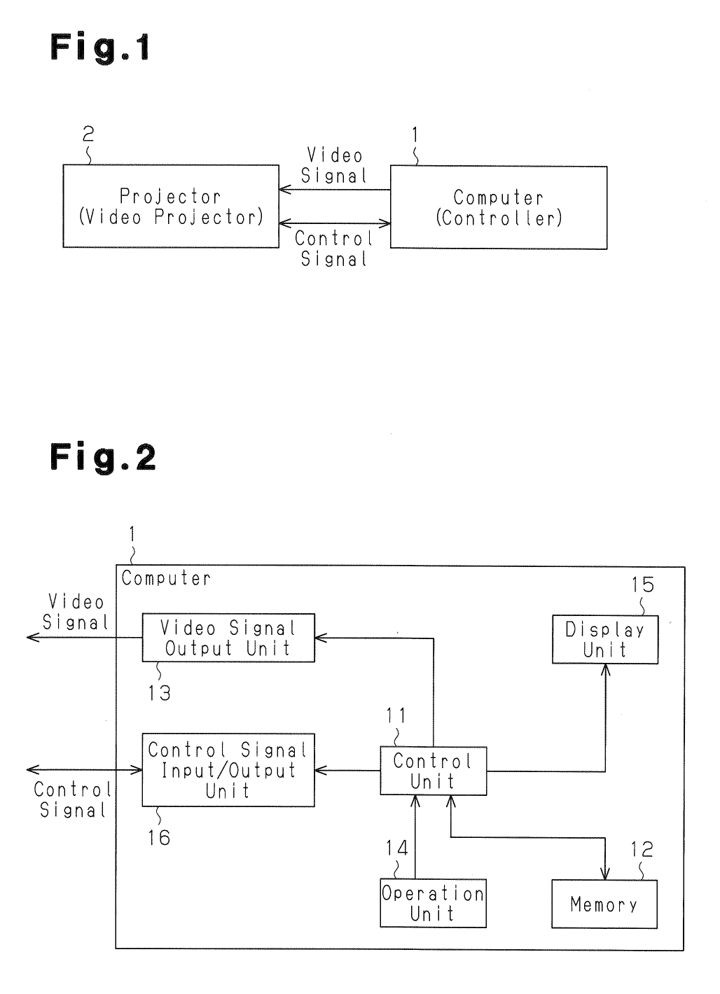

Referring to FIG. 1, an image display system according to a first embodiment includes a computer 1, which serves as a controller, and a projector 2, which serves as a video projector. The image display system according to the first embodiment will now be discussed with reference to FIGS. 1 to 10.

As shown in FIG. 2, the computer 1 includes a control unit 11, a memory 12, a video signal output unit 13, an operation unit 14, a display unit 15, and a control signal input/output unit 16. The control unit 11 controls various functional units in the computer 1. The memory 12 stores information such as programs. The video signal output unit 13 outputs video signals. The operation unit 14 is operated by a user. The display unit 15 displays an image. The control signal input/output unit 16 inputs and outputs control signals. The computer 1, which includes these elements, is formed by a personal computer (PC), which is a versatile electronic device.

The control unit 11 is an integrated circuit that outputs control signals or the like to the functional units of the computer 1. The control unit 11 is formed by, for example, a central processing unit (CPU) and executes a program stored in the memory 12 to generate signals for controlling the functional units of the computer 1.

The memory 12 may be a hard disk drive or a flash memory. The memory 12 stores information for images displayed by the projector 2 and information for controlling the projector 2 in addition to programs executed by the control unit 11.

The video signal output unit 13 includes a High-Definition Multimedia Interface (HDMI) terminal and a Video Graphics Array (VGA) terminal, which output video signals from the computer 1 to an external device. The information of an image stored in the memory 12 and the information of an image displayed on the display unit 15 are provided as video signals from the video signal output unit 13 to the projector 2.

The operation unit 14 includes, for example, a keyboard and a mouse, which are operated by the user. When the operation unit 14 is operated, the control unit 11 receives various types of signals, and the control unit 11 executes control in accordance with the operation contents of the operation unit 14.

The display unit 15 displays an image for the user of the computer 1. The display unit 15 displays an image based on the video signal output from the video signal output unit 13. Accordingly, the user may refer to the display unit 15 to check the image displayed by the projector 2.

The control signal input/output unit 16 includes, for example, a local area network (LAN) terminal connectable to a LAN cable, a RS-232C terminal, and a Universal Serial Bus (USB) terminal. A signal for controlling the projector 2 is output from the control signal input/output unit 16 to the projector 2.

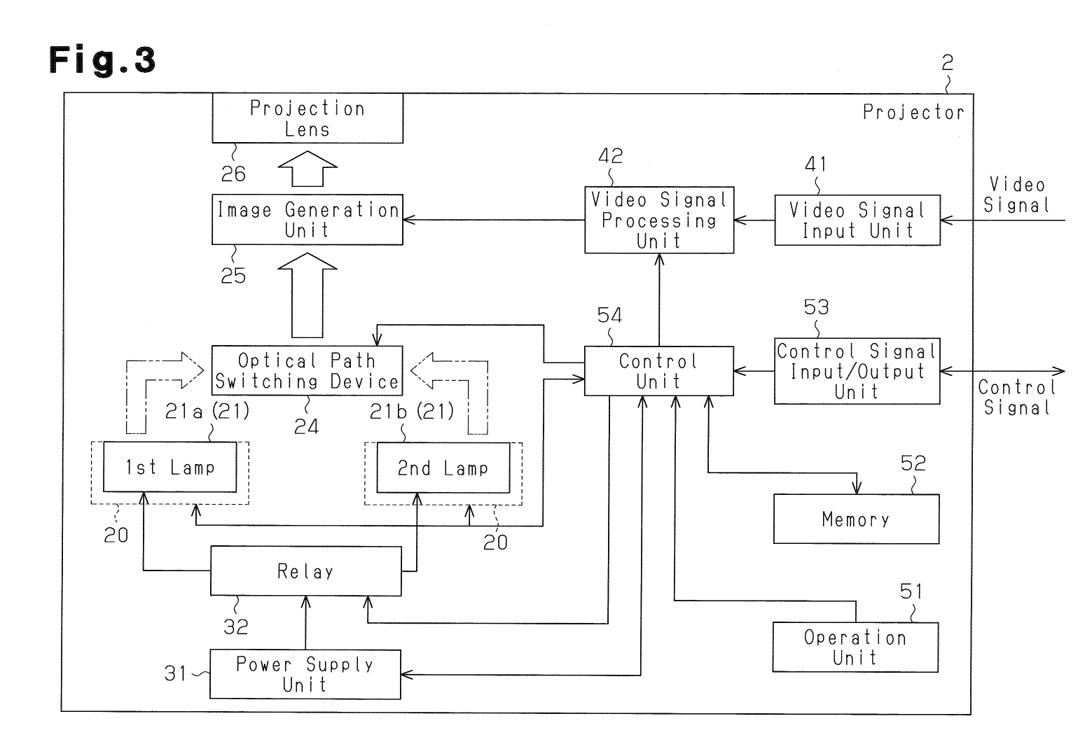

As shown in FIG. 3, the projector 2, which projects and displays an image on a plane such as a screen, includes various optical components for projecting and displaying images. For example, the projector 2 includes a plurality of lamps 21, an optical path switching device 24, an image generation unit 25, which generates an image with light, and a projection lens 26, which enlarges and projects an image. The projector 2 projects and displays an image to present a video content.

In the first embodiment, the lamps 21 of the projector 2 include a first lamp 21a and a second lamp 21b. The first lamp 21a serves as a first light source for displaying an image, and the second lamp 21b serves as a second light source for displaying an image. The first lamp 21a and the second lamp 21b are each accommodated in a lamp unit 20 and formed by a discharge lamp such as an ultrahigh pressure mercury lamp or a metal halide lamp.

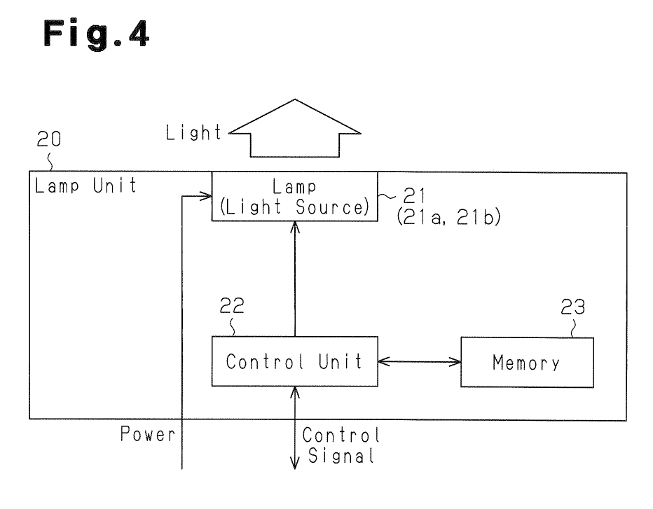

As shown in FIG. 4, the lamp unit 20 is a light source device including a single lamp 21, a control unit 22 provided exclusively for the single lamp 21, and a memory 23 for storing the cumulative activation time or the like of the lamp 21. The control unit 22 executes data processing based on a control signal received from a main control unit 54 (refer to FIG. 3) of the projector 2. For example, the control unit 22 stores information, such as the cumulative activation time and operation history of the lamp 21, in the memory 23 and reads information from the memory 23.

Referring to FIG. 3, the optical path switching device 24 switches the light guided to the image generation unit 25 between the light emitted from the lamp 21a or the light emitted from the second lamp 21b. For example, the optical path switching device 24 switches the optical path based on a control signal received from the control unit 54 by driving a reflection mirror connected to an electric motor. The use of such an optical path switching device 24 allows for the image generation unit 25 and the projection lens 26 to be shared by the optical paths formed by the lamps 21.

The image generation unit 25 includes a liquid crystal panel, which is a dot matrix type light valve, and a digital micromirror device (DMD), which has micromirrors arranged in a grating. The image generation unit 25 generates an image with the light emitted from the first lamp 21a or the second lamp 21b that is passed through the liquid crystal panel and reflected by the DMD. The image generation unit 25 drives the liquid crystal plane and the DMD based on the video signal.

The projection lens 26 includes a lens group, which enlarges and projects the light of the image generated by the image generation unit 25. The projector 2 projects the light of an image with the projection lens 26 to display the image on a screen, a wall, or the like.

Further, as shown in FIG. 3, the projector 2 includes a power supply unit 31 and a relay 32. The power supply unit 31 supplies power to the first lamp 21a and the second lamp 21b. The relay 32 switches the destination of the power supplied from the power supply unit 31 between the first and second lamps 21a and 21b.

The power supply unit 31 includes a circuit for obtaining power from a commercial power supply in correspondence with each functional unit of the projector 2 and supplies the first lamp 21a and the second lamp 21b with power via the relay 32. Based on a control signal received from the main control unit 54 of the projector 2, the power supply unit 31 controls the lamps 21 so that one is on, or activated, and the other is off, or deactivated. In addition to the first lamp 21a and the second lamp 21b, the power supply unit 31 supplies the control unit 54 of the projector 2, the control unit 22 of each lamp unit 20, and the like with power.

The relay 32 supplies one of the lamps 21 with the power from the power supply unit 31. That is, the relay 32 selectively supplies the first lamp 21a and the second lamp 21b with the power from the power supply unit 31. The relay 32 switches the destination of the power supply based on the control signal received from the main control unit 54 of the projector 2.

When power is supplied from the power supply unit 31 to the first lamp 21a, the first lamp 21a is on, or activated. In this state, the supply of power to the second lamp 21b is stopped. Thus, the second lamp 21b is off, or deactivated. In the same manner, when power is supplied from the power supply unit 31 to the second lamp 21b, the second lamp 21b is on, or activated. In this state, the supply of power to the first lamp 21a is stopped. Thus, the first lamp 21a is off, or deactivated.

The projector 2 includes a video signal input unit 41 and a video signal processing unit 42. The video signal input unit 41 receives a video signal from an external device connected to the projector 2. The video signal processing unit 42 performs predetermined signal processing on the video signal.

The video signal input unit 41 includes, for example, an HDMI terminal and a VGA terminal. In the first embodiment, the computer 1, which serves as an external device connected to the projector 2, provides the projector 2 with a video signal via the video signal input unit 41.

The video signal processing unit 42 performs various types of signal processing on a video signal provided to the projector 2. The video signal is then provided from the video signal processing unit 42 to the image generation unit 25.

The projector 2 further includes an operation unit 51, a memory 52, and a control signal input/output unit 53. The operation unit 51 is operated by the user. The memory 52 stores information such as programs. The control signal input/output unit 53 inputs and outputs control signals to and from the external device connected to the projector 2.

The operation unit 51 includes, for example, buttons or a touch panel pushed by the user. When the operation unit 51 is operated, various types of signals are input to the control unit 54, and the control unit 54 executes controls in accordance with the operation contents of the operation unit 51.

The memory 52 includes a non-volatile memory (e.g., flash memory) that allows for information to be written and deleted. In addition to programs executed by the control unit 54, information such as the activation periods of the lamps 21 is stored in the memory 52.

The control signal input/output unit 53 includes, for example, a LAN terminal connectable to a LAN cable, an RS-232C terminal, and a USB terminal. The control signal input/output unit 53 provides the projector 2 with signals output from the computer 1 to control the projector 2.

The control unit 54 is an integrated circuit that outputs control signals or the like to each functional unit of the projector 2. The control unit 54 is formed, for example, by a microcomputer and executes the programs stored in the memory 52 to control each functional unit of the projector 2.

Based on the information stored in the memory 52 and signals provided from an external device connected to the projector 2, the control unit 54 controls the optical path switching device 24, the power supply unit 31, and the relay 32 to switch the lamps 21. In other words, the control unit 54 controls the power supplied by the power supply unit 31 and the relay 32 to control the activation and deactivation of the lamps 21. In the first embodiment, the control unit alternatively switches the activation of the first lamp 21a and the activation of the second lamp 21b.

Further, the control unit 54 performs various types of determinations based on the executed program. For example, the control unit 54 determines whether or not to activate a predetermined one of the lamps 21 based on factors like the cumulative activation time of the lamp 21 or operational history such as deactivation of the lamp 21, which are stored in the memory 23.

The user may set the activation periods of the lamps 21. The control unit 54 of the projector 2 switches the activated lamp 21 based on the activation periods. When the projector 2 is used for digital signage, the user would be the administrator or the like of the projector 2.

Based on the activation period set by the user, the activation period for each activation of at least one of the lamps 21 is settable, or programmable, by the control unit 54. In the first embodiment, the two lamps 21a and 21b are alternately activated. Accordingly, each lamp 21 is repeatedly activated and deactivated and thereby activated for a number of times. Therefore, the control unit 54 of the first embodiment sets the activation period of each of the lamps 21 (21a and 21b) for each activation. The activation period is set in accordance with the reproduction time of the displayed image.

The projector 2 according to the first embodiment is operated in three selectable activation modes to activate the lamps 21. More specifically, the projector 2 includes a manual switching mode that switches the lamp 21 that is activated when operated by the user, an automatic switching mode that switches the lamp 21 that is activated based on the set activation period, and a remote control mode that switches the lamp 21 that is activated based on a signal input from an external device.

In the manual switching mode, the lamp 21 that is activated is switched when the user operates the operation unit 51. In the automatic switching mode, the lamp 21 that is activated is automatically switched based on an activation program, which includes information of the activation period stored in the memory 12.

In the remote control program, the lamp 21 that is activated is switched based on the control of the computer 1, which serves as an external device connected to the projector 2. In the first embodiment, when the remote control mode is selected, the activated lamp 21 is switched when the operation unit 14 of the computer 1 is operated.

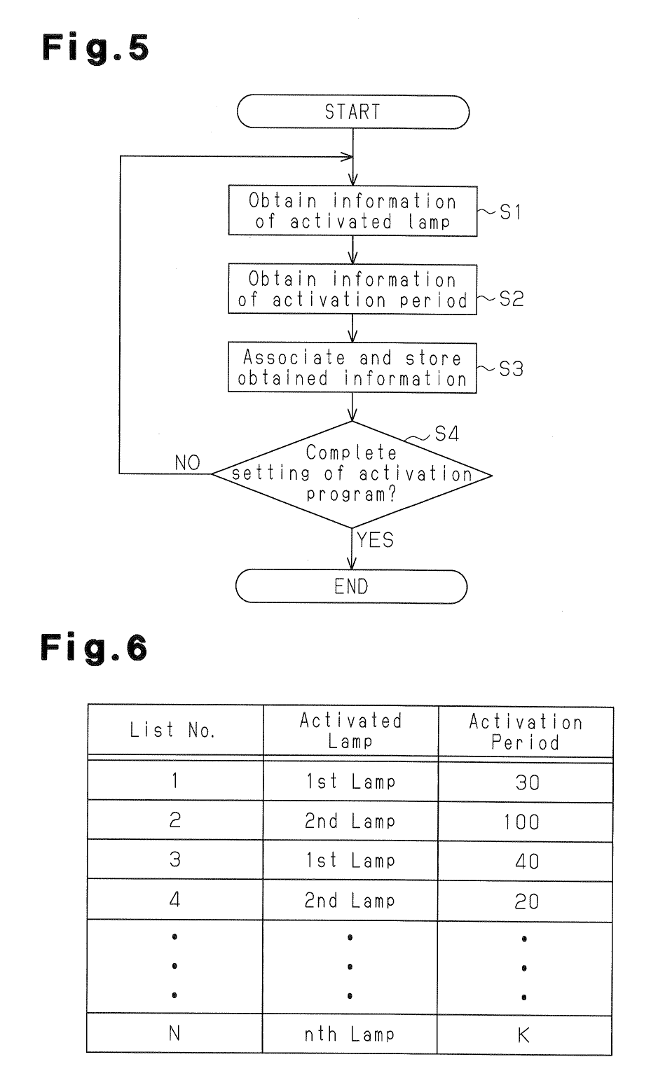

With reference to FIG. 5, the processing performed to set an activation program for the automatic switching mode will now be discussed. The control unit 54 starts the series of processes shown in FIG. 5 when, for example, receiving a setting start signal for the activation program from the operation unit 51. The activation program need only be set before the lamps 21 are actually activated in the automatic switching mode. Accordingly, the activation program may be set in advance before the automatic switching mode is selected or immediately after the automatic switching mode is selected.

As shown in FIG. 5, the control unit 54 first obtains information of the lamp 21 that is to be activated (step S1). For example, the control unit 54 obtains information of the one of the lamps 21 that is to be activated based on the selection performed with the operation unit 51 by the user. In the first embodiment, either one of the first lamp 21a and the second lamp 21b is selected.

Then, the control unit 54 obtains information for the length of time, or period, of a single activation of the selected lamp 21 (step S2). For example, the control unit 54 obtains the activation period information based on the selection performed with the operation unit 51 by the user.

Next, the control unit stores in the memory 52 the information of the lamp 21 obtained in step S1 in association with the information of the activation period obtained in step S2 (step S3). This sets the period for a single activation of the single lamp 21.

Finally, the control unit 54 determines whether or not to complete the setting of the activation program (step S4). For example, the control unit 54 determines whether or not an operation for completing the setting of the activation program has been performed with the operation unit 51 and completes the setting of the activation program when receiving a setting completion signal from the operation unit 51.

When the setting of the activation program is not completed, the control unit 54 repeats steps S1 to S3. By repeating steps S1 to S3, the lamp 21 that is to be activated and the activation period for each activation of the lamp 21 are set so as to generate a program list such as that shown in FIG. 6.

The program list shown in FIG. 6 is one example of an activation pattern of the lamps 21 including the set contents of the activation program and stored in the memory 52. In FIG. 6, “n” represents a natural number and is either “1” or “2” in the first embodiment. In FIG. 6, “K” represents a natural number corresponding to the time length of the displayed image.

In the first embodiment, the information for the lamp 21 that is to be activated and the information for the activation period are associated with a list number. The list number is a distinguishable code and indicates an activation order of the lamps 21. For example, the program list shown in FIG. 6 shows a pattern for activating the lamps 21 in the order of “activate the first lamp 21a for thirty minutes”, “activate the second lamp 21b for one hundred minutes”, “activate the first lamp 21a for forty minutes”, and “activate the second lamp 21b for twenty minutes”. In other words, the activation periods shown in FIG. 6 indicates the time intervals in which the activated lamps 21 are switched. Accordingly, in the first embodiment, the time intervals for switching the lamps 21 are set by the activation periods of the lamps 21.

The various information of the program list generated with the operation unit 51 as described above is stored in the memory 52.

In the first embodiment, at least part of the activation pattern of the lamps 21 (i.e., the program list) may be set as a repeat pattern. When a repeat pattern is set, the control unit 54 switches the activated lamps 21 by repeating the repeat pattern.

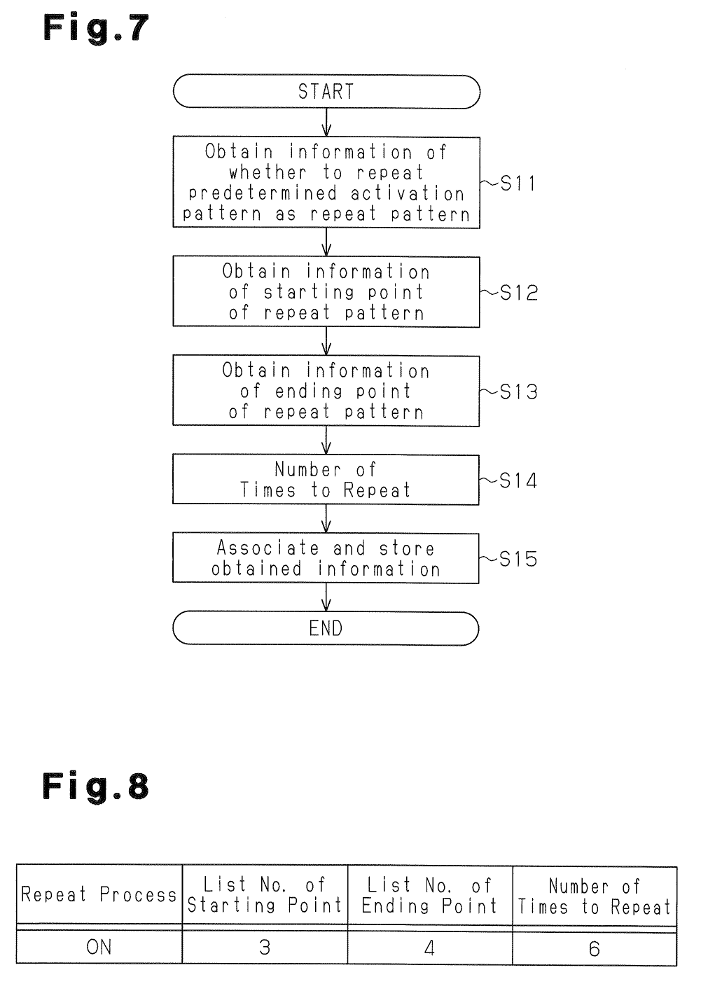

With reference to FIG. 7, the processing performed to set the repeat pattern will now be discussed. The control unit 54 starts the series of processes shown in FIG. 7 when, for example, receiving a setting start signal for the repeat pattern from the operation unit 51.

As shown in FIG. 7, the control unit 54 obtains information of whether or not to repeat a predetermined activation pattern as a repeat pattern based on the activation pattern, which has been set as described above (step S11). For example, the control unit 54 obtains information of whether or not to validate execution of the repeat pattern based on the selection performed with the operation unit 51 by the user.

Then, the control unit 54 obtains information of a starting point of the repeat pattern (step S12). For example, based on the selection performed with the operation unit 51 by the user, the control unit 54 obtains one of the list numbers in the program list shown in FIG. 6 as the starting point of the repeat pattern.

Next, the control unit 54 obtains information of an ending point of the repeat pattern (step S13). For example, based on the selection performed with the operation unit 51 by the user, the control unit 54 obtains one of the list numbers in the program list shown in FIG. 6 as the ending point of the repeat pattern. The list number selected as the ending point is a list number of which activation order comes after the list number selected in step S12.

Then, the control unit 54 obtains information for the number of times to repeat—the repeat pattern (step S14). For example, based on the selection performed with the operation unit 51 by the user, the control unit 54 obtains the number of times to repeat the activation pattern from the starting point of the repeat pattern to the ending point of the repeat pattern.

Further, the control unit 54 associates and stores in the memory 52 information for whether or not to repeat the repeat pattern, information for the starting point and ending point of the repeat pattern, and information for the number of repetitions (step S15). As a result, as shown in the example of FIG. 8, a repeat list is generated including the information for the repeat pattern (starting point and ending point), the information for whether or not to validate execution of the repeat pattern (ON/OFF), and the information for the number of repetitions.

The repeat list shown in the example of FIG. 8 is stored in the memory 52 in step S15. Under the item labeled as “repeat process” in FIG. 8, “ON” indicates that execution of the repeated pattern is validated. Accordingly, the repeat list of FIG. 8 indicates that the activation pattern of list numbers 3 to 4 in the program list of FIG. 6 is to be repeated six times. More specifically, based on the program list of FIG. 6 and the repeat list of FIG. 8, the control unit 54 executes a program pattern of “activate the first lamp 21a for thirty minutes” and “activate the second lamp 21b for one hundred minutes”. Then, the control unit 54 repeats for six times a program pattern of “activate the first lamp 21a for forty minutes” and activate the second lamp 21b for twenty minutes”.

The storage of the repeat list in the memory 52 completes the setting of the repeat pattern. In step S11, when validation of the execution of the repeat pattern is not selected, the setting of the repeat pattern may be cancelled without performing the operations of steps S12 to S14.

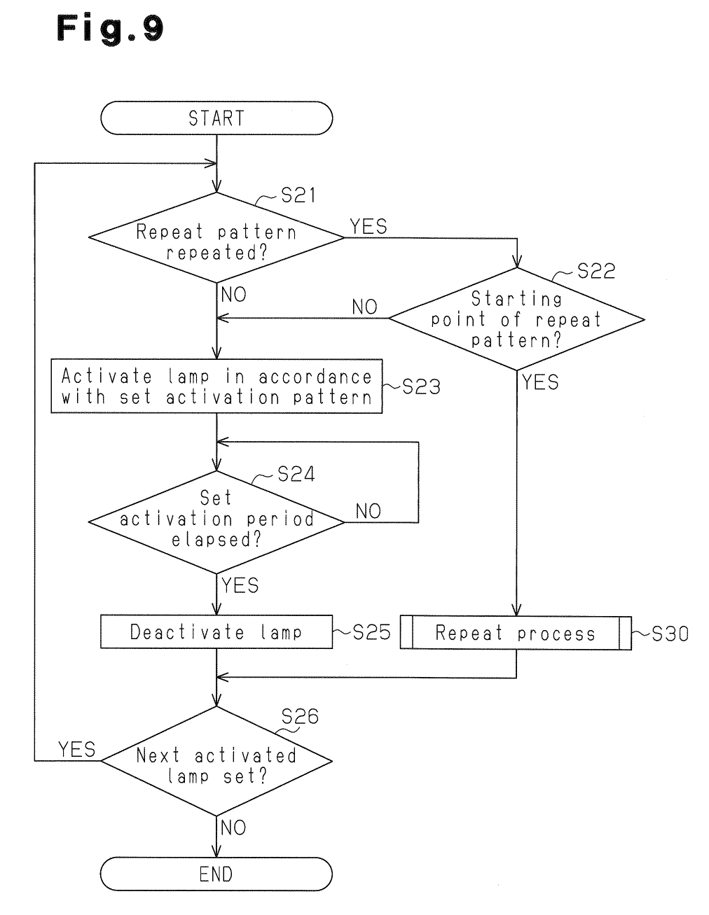

The flow of an activation switching control for the lamps 21 will now be discussed with reference to FIG. 9. The control unit 54 starts the series of processes shown in FIG. 9 when, for example, the automatic switching mode is selected with the operation unit 51.

As shown in FIG. 9, the control unit 54 first refers to the repeat list and determines whether or not execution of the repeat pattern has been validated (step S21). When the repeat list is not generated, the control unit 54 determines that there is no repeat pattern (step S21: NO).

When execution of the repeat pattern is validated, the control unit 54 determines whether or not the present list number, which is in accordance with the program list of, for example, that shown in FIG. 6, is the starting point of the repeat pattern set in the repeat list of, for example, that shown in FIG. 8 (step S22).

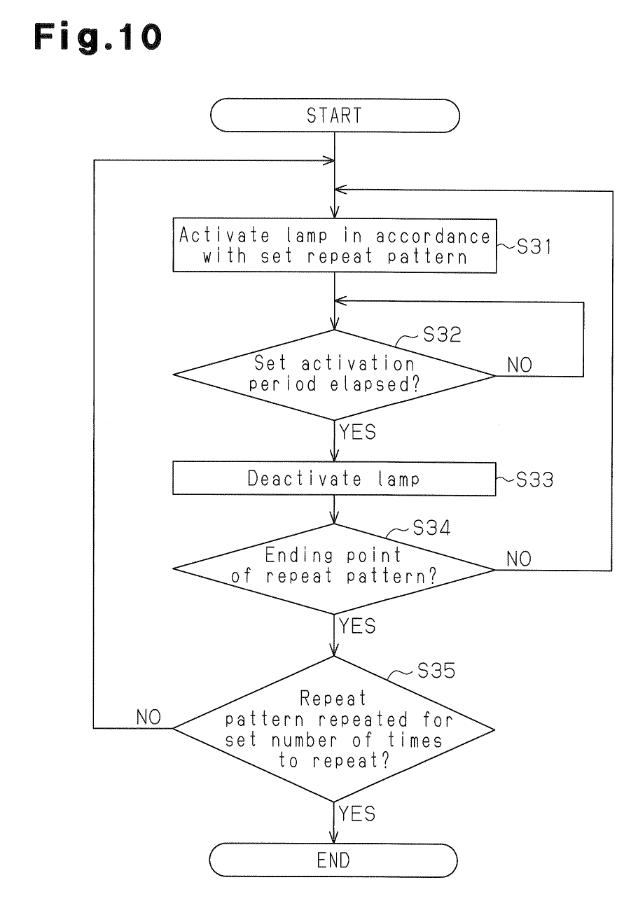

When the present list number is the starting point of the repeat pattern, the control unit 54 performs the repeat process shown in FIG. 10 (step S30) based on the set repeat list.

When execution of the repeat pattern is not validated (step S21: NO), the control unit 54 executes the activation program for the present list number in accordance with the program list (step S23). Further, when the present list number is not the starting point of the repeat pattern (step S22: NO), the repeat process is suspended, and the control unit 54 executes the activation program for the present list number. In this manner, in step S23, the control unit 54 activates the predetermined one of the lamps 21 (the first lamp 21a or the second lamp 21b) designated by the activation program.

Next, the control unit 54 determines whether or not the continuous activation period of the lamp 21 (21a or 21b) that started activation has elapsed a set activation period (step S24). For example, the control unit 54 uses a timer (not shown) to measure the elapsed time from when activation of the lamp 21 started to determine whether or not the measured elapsed time has reached a set activation period.

When the set activation period has elapsed, the control unit 54 deactivates the lamp 21 that started activation in step S23 (step S25). For example, the first lamp 21a corresponding to list number 1 in FIG. 6 is turned off after thirty minutes elapses from when activation started. Further, the second lamp 21b corresponding to list number 2 in FIG. 6 is turned off after one hundred minutes elapses from when activation started. Accordingly, the lamp 21 that starts activation in step S23 remains activated until the set activation period elapses.

Then, the control unit 54 refers to the program list and determines whether or not the lamp 21 that is activated next is set (step S26).

When the lamp 21 that is to be activated next is set, the control unit 54 repeats the operations from step S21. As a result, based on the activation periods set in the program list, the lamps 21 that are activated are sequentially switched so as to conform to the set activation pattern.

With reference to FIG. 10, the flow of the repeat process of step S30 will now be discussed. First, the control unit 54 activates the predetermined lamp 21 (21a or 21b) in accordance with the repeat pattern set in the repeat list (step S31). For example, in the case of the repeat list shown in FIG. 8, the control unit 54 activates the first lamp 21a, which corresponds to list number 3, which is set as the starting point.

Then, in the same manner as in step S24, the control unit 54 determines whether or not the continuous activation period of the lamp 21 that started activation has reached a set activation period (step S32).

When the set activation period has elapsed, the control unit 54 deactivates the lamp 21 that started activation in step S31 (step S33).

Then, the control unit 54 determines whether or not the list number of the activation program of which execution has presently been completed is an ending point of the repeat pattern (step S34). For example, in the case of the repeat list shown in FIG. 8, the control unit 54 determines whether or not the activation program of which execution has presently been completed is the activation program corresponding to list number 4.

When the list number is not the ending point of the repeat pattern (step S34: NO), the control unit 54 repeats steps S31 to 533. By repeating steps S31 to 533, the activated lamps 21 are switched in accordance with the repeat pattern from the starting point to the ending point.

When the list number is the ending point of the repeat pattern (step S34: YES), the control unit 54 determines whether or not the repeat pattern has been repeated for the set number of times to repeat (step S35).

When the repeat pattern has not be repeated for the set number of times to repeat (step S35: NO), the operations of steps S31 to S34 are repeated. As a result, the repeat pattern from the starting point to the ending point is repeated for the set number of times to repeat.

When the repeat pattern has been repeated for the set number of times to repeat (step S34: YES), the repeat process ends and the processing proceeds to step S26 of FIG. 9.

When the lamp 21 that is to be activated reaches the end of its life or when the lamp 21 becomes defective, the switching of the lamps 21 is performed in a manner irrelevant to the set activation program even if the automatic switching mode is selected. In other words, when the automatic switching mode is selected and the control unit 54 determines that the predetermined lamp 21 cannot be activated to display an image, the switching control of the lamps 21 based on the set activation program is prohibited.

The image display system of the first embodiment has the advantages described below.

(1) The activation period of each lamp 21 is set for each activation. That is, the control unit 54 is capable of setting the activation period for each activation of the repetitively activated first lamp 21a or second lamp 21b. This increases the freedom for setting the activation period of each lamp 21 and allows for the activation pattern of each lamp 21 to be flexibly set. Accordingly, the activation pattern of the lamps 21 is not fixed and is variable in accordance with the various video contents presented with the projector 2. This enables the closing of a video content to be synchronized with the switching of the activated lamps 21 so that the presentation of the video contents is not interrupted when switching the activation of the lamps 21.

(2) The activation period is settable for each activation of each lamp 21 (i.e., the first lamp 21a and the second lamp 21b) in the projector 2. This allows for flexible setting of an activation pattern that combines all of the lamps 21.

(3) The user may freely set the activation period of each lamp 21 by operating the operation unit 51 of the projector 2.

(4) The control unit 54 programs the activation pattern of the lamps 21 based on the activation periods set by the user with the operation unit 51. This allows for the activation pattern of the lamps 21 to be set with further flexibility. That is, the programmed activation pattern of the lamps 21 may be one that activates the lamps 21 in an order that is desirable for the user.

(5) The control unit 54 executes a control for switching and activating the lamps 21 based on the information stored in the memory 52 (i.e., the activation periods set in the program list). Accordingly, the external device (computer 1), which is connected to the projector 2, does not have to be used to control the switching timing of the lamps 21.

(6) The control unit 54 sets whether or not to use at least part of the activation pattern in the program list as a repeat pattern. When using the repeat pattern, the control unit 54 repeats part of the program list in accordance with the repeat pattern. This allows for elimination of the burden for setting the activation period of each lamp 21 for each activation.

(7) The control unit 54 repeats the repeat pattern for the number of times set in the repeat list. Thus, a predetermined activation pattern included in the program list may be repeated for the number of times desired by a user.

(8) The control unit 54 is capable of selectively executing the automatic switching mode, which switches the lamps 21 based on preset activation periods, and the manual switching mode, which switches the lamps 21 based on a user operation. Thus, the user may select the desirable activation mode in accordance with the application of the projector 2.

(9) The control unit 54 is capable of further selecting the remote control mode, which switches the lamps 21 based on signals provided from the computer 1. Accordingly, when the image display system includes a plurality of projectors 2, the use of the remote control mode eliminates the need for setting the activation pattern for each projector 2 and facilitates the control of the plurality of projectors 2.

### Second Embodiment

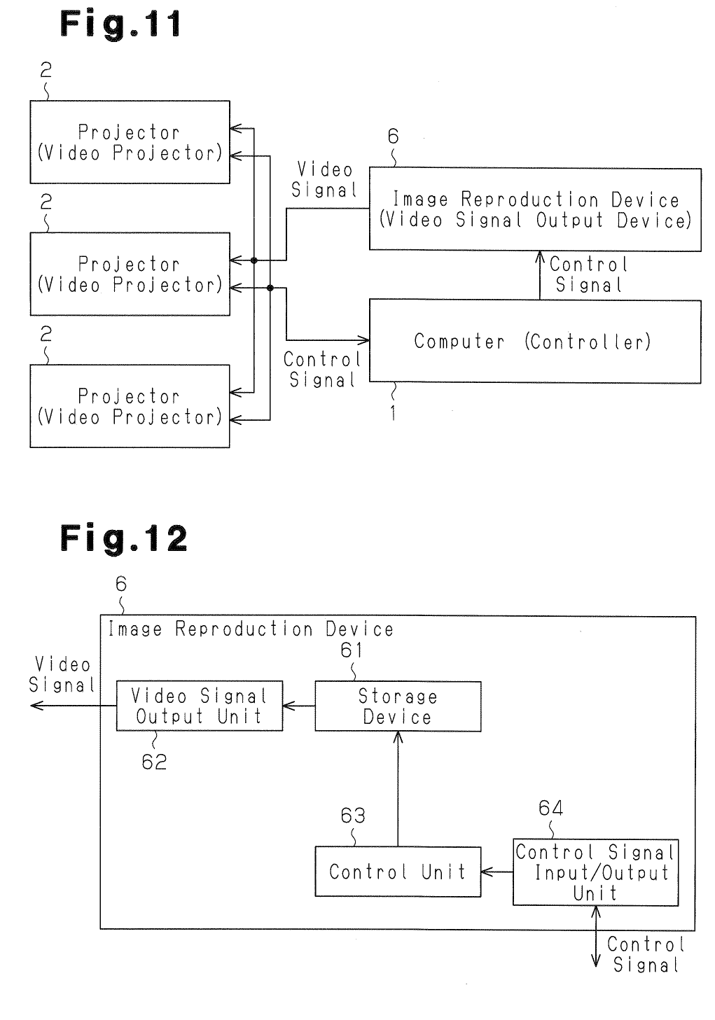

An image display system according to a second embodiment will now be discussed with reference to FIGS. 11 to 18. The image display system of the second embodiment includes a computer 1 (controller), which has a structure similar to that of the first embodiment shown in FIG. 2, and a plurality of projectors 2 (video projectors 2), each having a structure similar to that of the first embodiment shown in FIGS. 3 and 4. To avoid redundancy, like or same reference numerals are given to those components that are the same as the corresponding components of the first embodiment. Such components will not be described.

As shown in FIG. 11, the image display system further includes an image reproduction device 6, which serves as a video signal output device that outputs video signals to the projectors 2.

In the second embodiment, the memory 12 of the computer 1 further stores information for controlling the image reproduction device 6. The image reproduction device 6 is controlled by signals from the control signal input/output unit 16 of the computer 1. The computer 1 retrieves information related to the lamps 21 and information related to video contents through the control signal input/output unit 16 and stores the retrieved information in the memory 12 of the computer 1.

In the second embodiment, the image reproduction device 6, which is an external device, provides each projector 2 with a video signal via the video signal input unit 41 of each projector 2. Each projector 2 provides the computer 1 with signals representing information related to the lamps 21 via the control signal input/output unit 53. The information related to the lamps 21 includes, for example, the quantity of the lamps 21 in each projector 2 and lamp IDs for distinguishing each lamp 21.

As shown in FIG. 12, the image reproduction device 6 includes a storage device 61, a video signal output unit 62, a control unit 63, and a control signal input/output unit 64. The storage device 61 reads video information stored in an electronic storage medium (not shown). The video signal output unit 62 outputs the video information read by the storage device 61 as a video signal. The control unit 63 controls each functional unit in the image reproduction device 6. The control signal input/output unit 64 receives control signals from the computer 1, which is an external device.

The storage device 61 is, for example, an optical drive that reads image information from an optical disk such as a DVD serving as an electronic storage medium. The video signal output unit 62 includes an HDMI terminal or VGA terminal for outputting video signals to each projector 2 connected to the image reproduction device 6. The electronic storage medium stores information for images corresponding to various types of video contents. The storage device 61 reads video information from the electronic storage medium and outputs the video information as a video signal to each projector 2 via the video signal output unit 62 based on a control signal provided from the control unit 63.

The control unit 63 is an integrated circuit for outputting a control signal to each functional unit of the image reproduction device 6. The control unit 63 is formed by, for example, a microcomputer and provides the storage device 61 with a control signal for outputting the video signal to each projector 2 based on a control signal provided from the computer 1.

The control signal input/output unit 64 includes, for example, a LAN terminal connectable to a LAN cable, an RS-232C terminal, and a USB terminal. The control signal input/output unit 64 provides the image reproduction device 6 with a control signal from the computer 1. The control signal includes, for example, a signal for outputting a predetermined video signal from the image reproduction device 6. Further, the image reproduction device 6 provides the computer 1 with information related to a video content via the control signal input/output unit 64. Information related to a video content includes, for example, a video reproduction time, which is the presentation time of a video content, and a video content ID, which is for distinguishing each of a plurality of video contents.

Accordingly, in the second embodiment, the image reproduction device 6 provides the projectors 2 with video signals. That is, the control signal provided from the computer 1 controls the projectors 2 and the image reproduction device 6.

In the second embodiment, the activation period of each lamp 21, which is activated for a number of times, is set for each activation. The activation period is set in accordance with the reproduction time of the displayed image by, for example, operating the operation unit 14 of the computer 1.

In the second embodiment, the projectors 2 are operated in any one of three selectable activation modes, that is, the manual switching mode, the automatic switching mode, and the remote control mode. In particular, the remote control mode will now be discussed. When the remote control mode is selected, the control unit 11 of the computer 1 executes a control program including an activation program stored in the memory 12 to automatically switch the activated lamps 21.

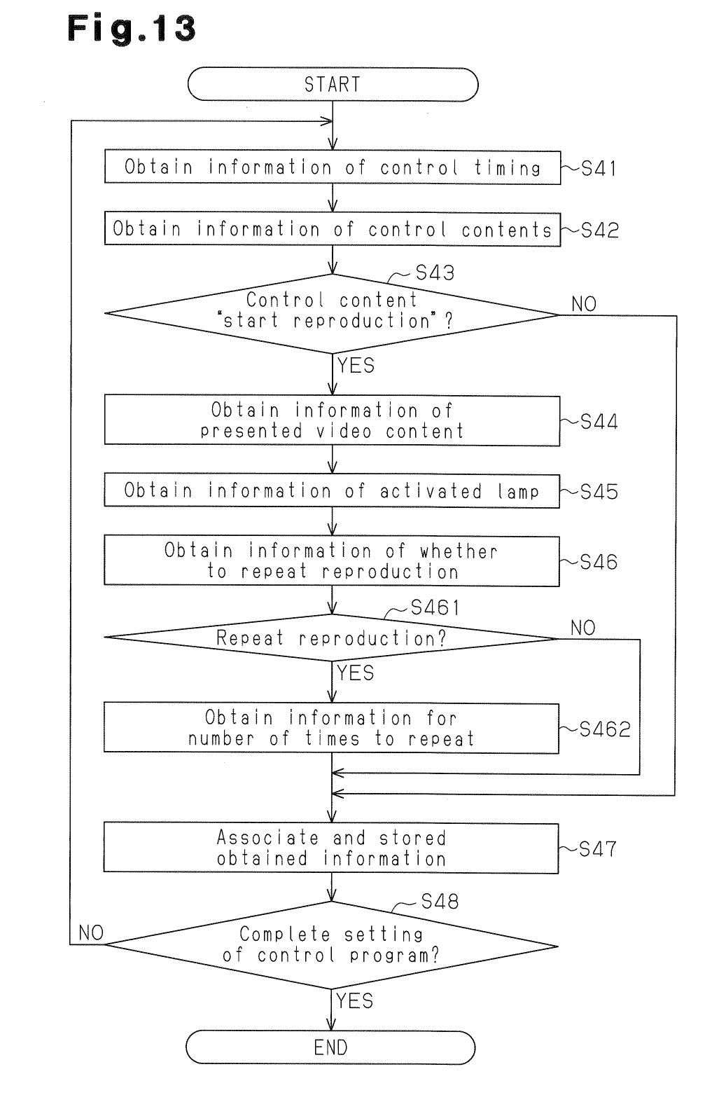

The flow of the control program related to the remote control mode will now be discussed with reference to FIG. 13. The control unit 11 of the computer 1 starts the series of processes shown in FIG. 13 when receiving a setting start signal for the activation program from the operation unit 14. The control program need only be set before actually controlling the activation of the lamps 21 in the remote control mode.

As shown in FIG. 13, the control unit 11 first obtains control timing information indicating the starting time or changing time for the control operation of the projectors 2 and the image reproduction device (step S41). For example, the control unit 11 obtains the time designated by a user with the operation unit 14 as control timing. Alternatively, as will be described later, the control timing may be automatically set based on previous control contents.

Then, the control unit 11 obtains the information of the control contents of the projector 2 and the image reproduction device 6 (step S42). For example, the control unit 11 selects the control contents designated by a user with the operation unit 14. Alternatively, as will be described later, the control timing may be automatically set based on the previous control contents. In the second embodiment, in step S42, one of “start reproduction”, “end reproduction”, and “switch lamps” is selected as the control content. The phrase “start reproduction” refers to a control that starts the output of a video signal from the image reproduction device 6 and activates the lamps 21 of the projectors 2. The phrase “end reproduction” refers to a control that stops the output of a video signal from the image reproduction device 6. The phrase “switch lamps” refers to a control for deactivating an activated lamp 21 to switch activated lamps 21.

Next, the control unit 11 determines whether or not the control content is “start reproduction” (step S43).

When the control content is “start reproduction”, the control unit 11 obtains information of the video content that is to be presented (step S44). For example, the control unit 11 selects a video content designated by a user with the operation unit 14.

Then, the control unit 11 obtains information of the lamp 21 that is to be activated (step S45). For example, the control unit 11 selects the lamp 21 designated by the user with the operation unit 14. The selected lamp 21 is activated at the starting time, which has been set as the control timing. In the same manner as in the first embodiment, in each projector 2, the lamps 21 include a first lamp 21a and a second lamp 21b. Accordingly, the control unit 11 selects either one of the first lamp 21a and the second lamp 21b.

Next, the control unit 11 obtains information of whether or not to repeat reproduction of the image (contents) selected in step S44 (step S46). The repeat reproduction information may be set with, for example, the operation unit 14. If a repeat reproduction function is valid, when the presentation of a video content ends within the activation period of the lamp 21 (i.e., when the reproduction of an image ends), the presentation of the video content is repeated.

Then, based on the information obtained in step S46, the control unit 11 determines whether or not to repeat reproduction of the image (step S461).

When repeating reproduction (step S461: YES), the control unit 11 obtains information of the number of times for repeating reproduction (step S462). The number of times to repeat may be set, for example, with the operation unit 14. When reproduction is not repeated (step S461: NO), step S462 is not performed.

When the number of times to repeat is set in step S462, the control program may be set so as to repeat the control of “start reproduction” and “end reproduction” for the number of times set for repetition. When “end reproduction” is selected as the control content, the time for ending the presentation of a video content (i.e., the control timing of “end reproduction”) may be automatically set by adding the presentation time length of the video content to the time for starting the presentation of the video content (i.e., the control timing of “start reproduction”). Moreover, a time immediately after the ending time may be automatically set as a starting time for the presentation of a video content, and a further ending time for the presentation of the video content may be set by adding the presentation time length of the video content to the starting time.

Then, the control unit 11 associates and stores the information obtained in at least steps S41 and S42 (step S47). In this state, when “start reproduction” is selected as the control content in step S42, the control unit 11 associates the information obtained in steps S41, S42, and S44 to S46. That is, the control unit 11 associates and stores in the memory 12 information of the control timing, information of the control contents, information of the video contents that are to be presented, information of the lamp 21 that is to be activated, and information of whether or not to repeat reproduction. In this manner, the operation unit 14 is operated to store in the memory 12 the information of the control timing for “start reproduction” and the information of the lamp 21 that is to be activated. This sets the lamp 21 that is to be activated and the timing for activating the lamp 21.

Further, in step S47, information of the video content that is to be presented is stored in the memory 12 to set the image displayed by the projectors 2. Further, in step S47, the memory 12 stores in the memory 12 information of whether or not to repeat reproduction. This sets whether or not to repeat presentation of the video content.

When the control content is not “start reproduction” in step S43, that is, when “end reproduction” or “switch lamps” is selected in step S42, the control unit 11 proceeds to step S47 to associate and store in the memory 12 the information of the control timing obtained in step S41 and the information of the control content obtained in step S42.

Steps S41 to S47 are repeated. In this case, when “start reproduction” is selected in step S42, “end reproduction” may be automatically selected the next time S42 is performed. Further, in step S47, the information of the control timing of “start reproduction” and “end reproduction” may be stored in the memory 12. Accordingly, by repeating steps S41 to S47, the activation period is set for each activation of each lamp 21, which is activated a number of times.

When step S42 is performed the first time, “start reproduction” may be automatically set. Further, when “end reproduction” is selected in step S42, “end reproduction” may be selected the next time step S42 is performed. When “switch lamps” is selected in step S42, “start reproduction” may be automatically selected the next time step S42 is selected.

After “end reproduction” is selected in step S42, when “start reproduction” is selected the next time step S42 is performed, the control for switching the lamps 21 is not executed. Thus, step S45 does not have to be performed.

When “end reproduction” is selected in step S42, it is preferable that the control timing corresponding to the ending time for the presentation of a video content be automatically set in accordance with the presentation time of the video content (i.e., reproduction time of image) obtained from the video content information.

Finally, the control unit 11 determines whether or not to complete the setting of the control program (step S48). For example, the control unit 11 determines whether or not an operation for completing the setting of the control program has been performed with the operation unit and completes the setting of the control program when receiving a setting completion signal from the operation unit 14.

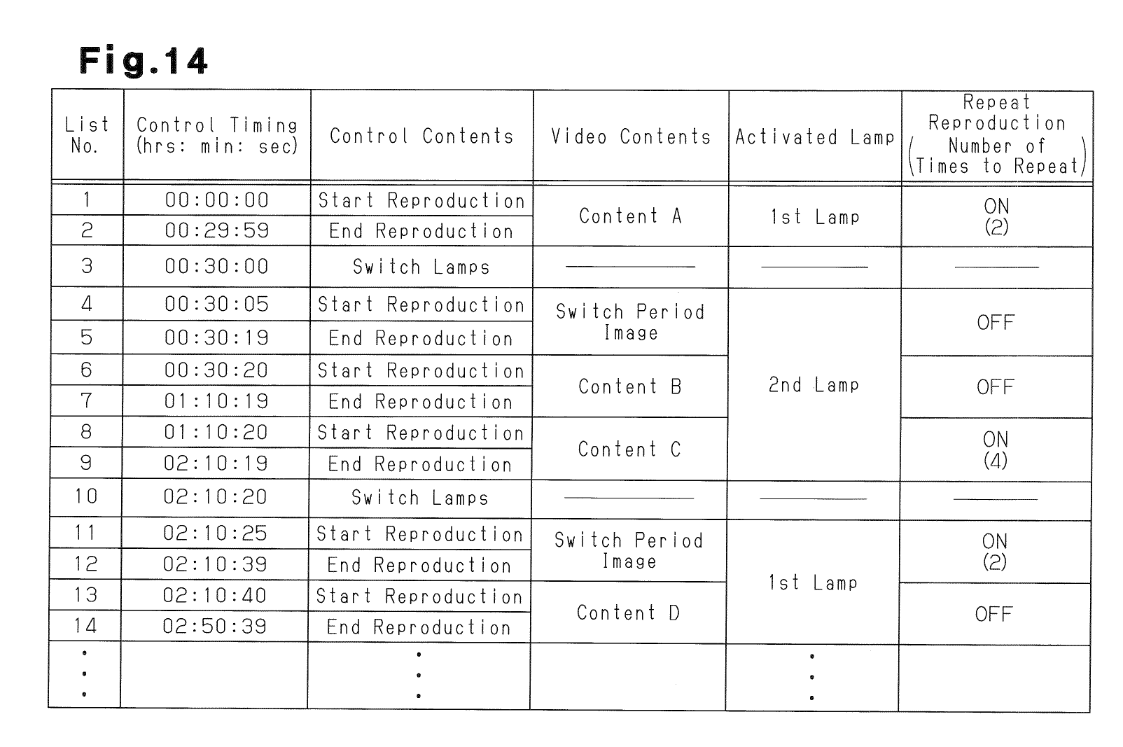

The control unit 11 repeats steps S41 to S47 when not completing the setting of the control program. The repetition of steps S41 to S47 sets the lamp 21 that is to be activated and the activation period for each activation of the lamp 21 and generates, for example, a program list as shown in FIG. 14.

The program list of FIG. 14 is stored in the memory 12 and shows one example of an activation pattern of the lamps indicating the setting contents of an activation program.

In the second embodiment, the information of the control timing, the information of the control contents, the information of the video contents, the information of the lamp 21 that is to be activated, and the information of whether or not to repeat reproduction are associated with a list number. The list number is a distinguishable code and indicates an activation order of the lamps 21. For example, the program list shown in FIG. 14 shows an activation pattern of the activated lamp 21 in the order of “activate the first lamp 21a for approximately thirty minutes”, “activate the second lamp 21b for approximately one hundred minutes”, and “activate the first lamp 21a for approximately forty minutes”.

Further, under the item labeled as “repeat reproduction” in FIG. 14, “ON” indicates that reproduction is repeated, and “OFF” indicates that reproduction is not repeated. For example, list numbers 1 to 2 in the program list of FIG. 14 indicates that reproduction of the image of content A is repeated for approximately thirty minutes during which the first lamp 21a is activated.

Under the item labeled as “video contents” in FIG. 14, “contents A”, “contents B”, “contents C”, and “contents D” represent commercial purpose video contents as the video contents that are to be presented. Under the same item labeled as “video contents”, “switch period image” represents non-commercial purpose video contents that are not used for advertisement of products and services or for the introduction of a facility.

In the second embodiment, when “switch lamps” is selected in step S42, “switch period image” is automatically selected as the video content the next time step S44 is performed. That is, referring to FIG. 14, for approximately twenty seconds from when activation starts with the lamp 21, which has been switched based on the “switch lamps” control, to when the illuminance of the lamp 21 stabilizes, selection of commercial purpose video contents (i.e., contents A to D) as the video content that is to be presented is prohibited. When an image is reproduced from immediately after activation of the lamp 21 starts, an image displayed when the illuminance is still insufficient is difficult to view. This may result in a disadvantage such as information not being conveyed to the audience. To cope with this problem, in the second embodiment, during the period from when activation starts to when the illuminance of the lamp 21 stabilizes, a non-commercial purpose is displayed. When the illuminance of the lamp 21 stabilizes, a commercial purpose image is shown.

The presentation time of the “switch period image”, that is, the reproduction time of the image displayed until the illuminance of the lamp 21 stabilizes may be changed by the user. Such a structure would satisfy a demand for setting a longer presentation time for the “switch period image” to ensure that commercial purpose video contents are presented in a state in which the illuminance is stabilized or ensure a demand for quickly presenting a video content other than the “switch period image”.

Further, the illuminance of the lamp 21 may be measured with a sensor, and presentation of a “switch period image” may be completed when the measured illuminance becomes greater than or equal to a fixed value. When the illuminance becomes greater than or equal to the fixed value, such a structure would ensure completion of the “switch period image” and allow for the presentation of a further video content. That is, an illuminance that is greater than or equal to the fixed value would be guaranteed when presenting the video contents of contents A to D, and the presentation of video content to the audience would be further ensured.

The various types of information in the program list generated with the operation unit 14 are stored in the memory 12.

The computer 1 provides the projectors 2 with the information of the activation program generated in the setting process (FIG. 13) of the control program. More specifically, based on the information stored in the memory 12 of the control timing and the lamp 21 that is to be activated, the computer 1 outputs from the control signal input/output unit 16 information of the time for switching the lamps 21 and information of the lamp 21 subject to switching. The information output as the control signal from the control signal input/output unit 16 is input to the control signal input/output unit 53 of each projector 2. Accordingly, the control signal input/output unit 53 is provided with a signal indicating the switching time of the lamps 21 as a signal indicating the activation period. This stores the activation program, which includes information of the activation period, in the memory 52 of each projector 2 and completes the setting of the activation program for the projector 2.

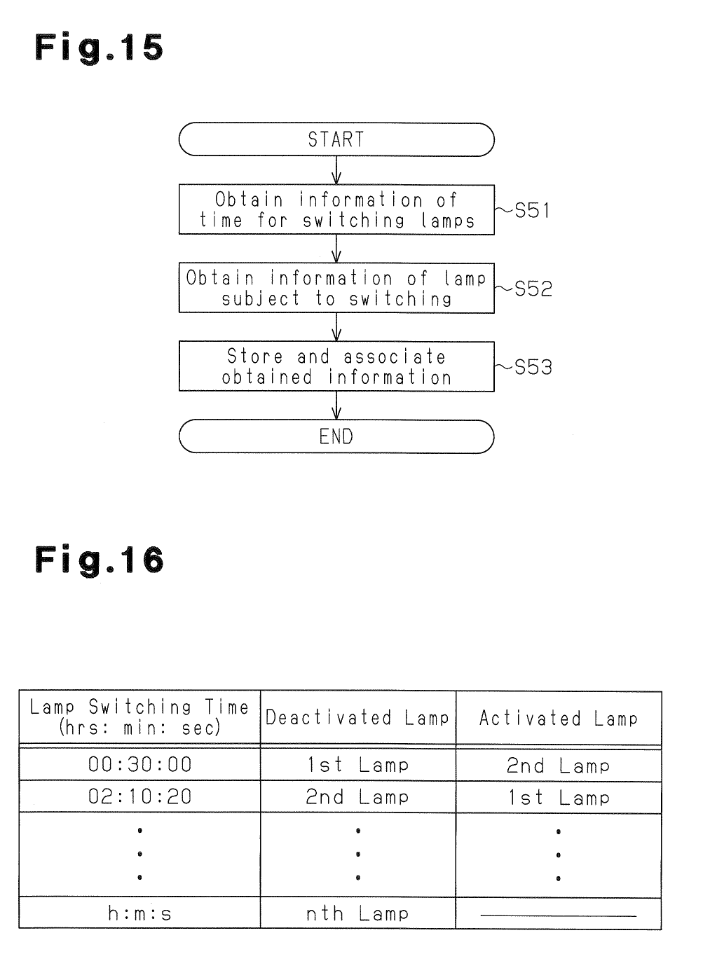

The flow of the process for storing the activation program in the memory of each projector 2 will now be discussed with reference to FIG. 15. The control unit 54 of the projector 2 starts the series of processes shown in FIG. 15 when, for example, receiving a signal for selecting the remote control mode from the computer 1. The storage of the activation program in the memory 52 is performed before the control process of the lamps 21 in the remote control mode.

As shown in FIG. 15, the control unit 54 of the projector 2 first obtains information of the time for switching the activated lamp 21 from the computer 1 via the control signal input/output unit 53 (step S51). Based on the information of the switching time, the control unit recognizes the timing for deactivating the activated lamp 21 and the timing for activating the deactivated lamp 21.

Next, the control unit 54 obtains information of the lamp 21 of which activation state is subject to switching from the computer 1 via the control signal input/output unit 53 (step S52). This obtains at least either one of information of the lamp 21 that is to be activated at a predetermined timing and information of the lamp 21 that is to be deactivated at a predetermined timing.

Further, the projector 2 associates and stores in the memory 52 the information of the switching time obtained in step S51 and the information of the lamp 21 subject to switching obtained in step S52 (step S53). As a result, a program list such as that shown in FIG. 16 is generated.

The program list shown in FIG. 16 is one example of an activation pattern of the lamp 21 showing the setting contents of the activation program and is stored in the memory 52 in step S53. In FIG. 16, “h” represents a natural number. Further, “m” and “s” represents an integer of 0 to 59. Additionally, in FIG. 16, “n” represents either “1” or “2” in the second embodiment.

The activation program shown in FIG. 16 has the same contents as the activation program included in the control program of FIG. 14 represents an activation pattern in which the activation of the lamps 21 is switched in the order of “activate the first lamp 21a for thirty minutes” and “activate the second lamp 21b for one hour forty minutes and twenty seconds”. In this manner, the time for switching the lamps 21 may be represented as the activation period for a single activation of the lamp 21, and the activation period of the lamp 21 is set by setting the time for switching the lamp 21.

The time for switching the lamps 21 and the activation periods of the lamps 21 are set based on a signal output from the computer 1 to the projectors 2. Accordingly, based on a control timing set by the user, the computer 1 controls the projectors 2 that the activated lamps 21 and activation periods are as set by the user. When controlling the activation of the lamps 21, the computer 1 also controls the image reproduction device 6 so as to display the image set by the user during the activation period, which is set by the user. Based on the control program and activation program, which are set as described above, a control for inputting to the projector 2 a video signal corresponding to the video content that is to be presented and a control for sequentially activating the lamps 21 are executed.

To output a video signal corresponding to a video content that is to be presented, the computer 1 provides the image reproduction device 6 with a control signal of “start reproduction” or “end reproduction” at the set control timing. The control signal of “start reproduction” is a signal for outputting a predetermined video signal from the image reproduction device 6. The control signal of “end reproduction” is a signal for stopping the output of a predetermined video signal from the image reproduction device 6.

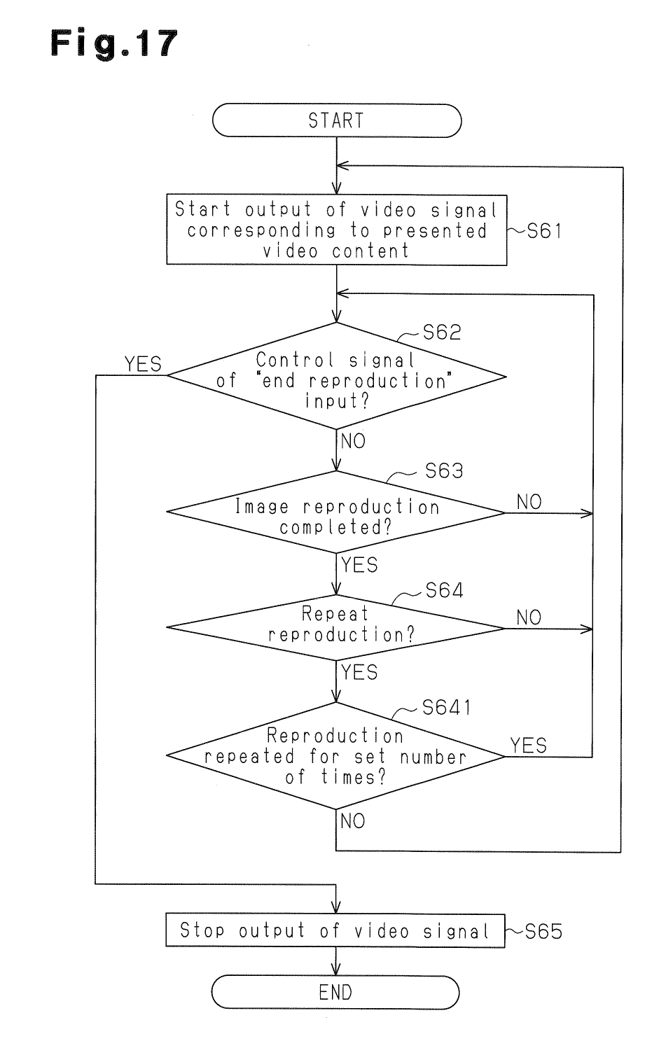

The flow of a process for providing a video signal corresponding to the video content that is to be presented from the image reproduction device 6 to each projector 2 will now be discussed with reference to FIG. 17. The control unit 63 of the image reproduction device 6 starts the series of processes shown in FIG. 17 when receiving from the computer 1 the control signal of “start reproduction” at a control timing set in the remote control mode. For example, in the control program shown in FIG. 14, when starting control in the remote control mode, the control unit 63 starts the series of processes shown in FIG. 17 at control timings such as thirty minutes and five seconds, thirty minutes and twenty seconds, and one hour ten minutes and twenty seconds.

As shown in FIG. 17, the control unit 63 first starts the output of the video signal corresponding to the video content that is to be presented (step S61). For example, in the case of the control program shown in FIG. 14, when starting the control process of “start reproduction” registered in list number 1, the control unit 63 receives a control signal for presenting content A from the computer 1 via the control signal input/output unit 64. Based on the control signal, the control unit 63 reads video information corresponding to content A and outputs the video information as a video signal from the video signal output unit 62. Contents A to D are commercial purpose contents, and images corresponding to contents A to D are for advertisement of a product or service or for introduction of a facility.

Then, the control unit 63 determines whether or not a control signal of “end reproduction” has been received from the computer 1 via the control signal input/output unit 64 (step S62).

When the control signal of “end reproduction” is not received, the control unit 63 determines whether or not image reproduction has been completed (step S63). When image reproduction has not been completed, step S62 is repeated. Further, the control unit 63 continues the output of the input signal corresponding to a video content until the control signal of “end reproduction” is received or until image reproduction is completed.

Further, when image reproduction is completed without receiving the control signal of “end reproduction”, the control unit 63 determines whether or not to repeat reproduction of the image (step S64). This determination is made based on a control signal representing repeat reproduction information and provided from the computer 1. That is, the control unit 63 determines whether the repeat reproduction information represents valid or invalid.

When image reproduction is not repeated, the processing returns to step S62. Accordingly, the control unit 63 maintains the state in which the video signal corresponding to a video content is output until receiving the control signal of “end reproduction”.

When repeating image reproduction, the control unit 63 determines whether or not the video content has been repeated for a predetermined number of times (step S641). The determination is made based on a control signal representing information indicating the number of repetitions and provided from the computer 1.

When the image has not been repeated for the number of times for repetition (step S62: NO), the processing returns to step S61. Accordingly, the output of a video signal corresponding to the video contents that is to be presented is restarted, and presentation of the video content is repeated until the required number of repetitions has been met. Further, the control unit 63 continues to output the video signal corresponding to the video content until receiving the control signal of “end reproduction”. In this manner, when repeating presentation of the video content, during the activation period of the lamp 21 that is synchronous with the control timings for “start reproduction” and “end reproduction”, the set image is repeatedly reproduced and displayed.

When receiving the control signal of “end reproduction” (step S62: YES), the control unit 63 stops outputting the video signal (step S65). In this manner, the control unit 63 controls the output of the video signal with the control signal from the computer 1. In other words, the computer 1 controls the image reproduction device 6 so as to output the video signal corresponding to the set image.

By repeating the series of processes described above, the image reproduction device 6 sequentially provides the projector 2 with video signals corresponding to various video contents. In the second embodiment, the image reproduction device 6 is connected to the plurality of projectors 2. Thus, the projectors 2 are provided with the same video signal.

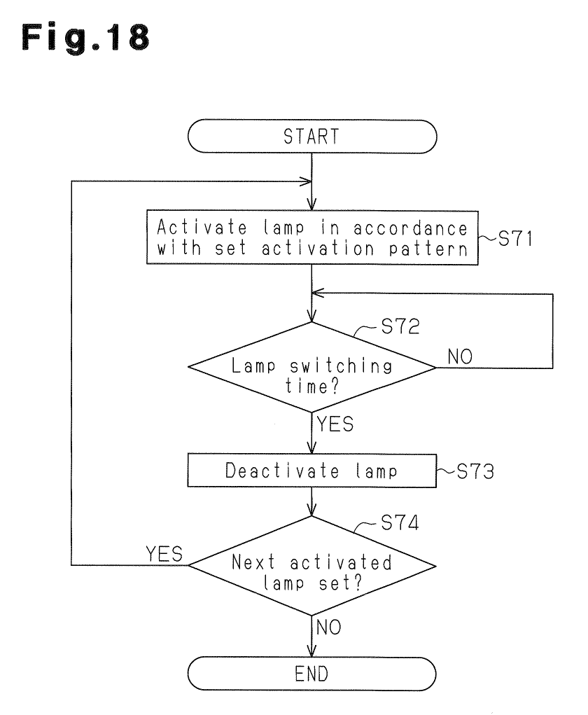

The flow of the operation of the projector 2 when sequentially activating the lamps 21 in the remote control mode will now be discussed with reference to FIG. 18. The series of processes shown in FIG. 18 start when the computer 1 provides the control unit 54 of each projector 2 with a signal for selecting the remote control mode, and the activation program (program list) of the lamps 21 is stored in the memory 52.

As shown in FIG. 18, the control unit 54 of the projector 2 activates the lamps 21 in accordance with the set activation pattern (step S71). For example, when the program list shown in FIG. 16 is stored in the memory 52, the control unit 54 first activates the first lamp 21a (for details, refer to FIG. 14). In this case, the control unit 54 continues to activate the first lamp 21a for thirty minutes and activates the second lamp 21b after thirty minutes elapses. In this manner, in step S71, based on the program list stored in the memory 52, the control unit 54 activates the first lamp 21a or the second lamp 21b.

Next, the control unit 54 determines whether the time for switching the activated lamp 21 has arrived (step S72). For example, the control unit 54 measures the elapsed time from when activation of the lamp 21 starts with a timer (not shown) and determines whether or not the measured elapsed time has reached a switching time for the lamp 21 stored in the memory 52.

When the switching time has not been reached, the process of step S72 is continued. When the switching time has been reached, the control unit 54 deactivates the lamp 21 that started activation in step S71 (step S73). For example, when the program list shown in FIG. 16 is stored in the memory 52 and the activation period of the first lamp 21a that first started activation reaches thirty minutes, the first lamp 21a is deactivated. Further, as the activation period of the second lamp 21b that started activation when thirty minutes elapsed reaches two hours ten minutes and twenty seconds, the second lamp 21b is deactivated. In this manner, in step S73, the control unit 54 activates the first lamp 21a or the second lamp 21b based on the program list stored in the memory 52. In other words, the lamp 21 that starts activation in step S71 continues activation until the next switching time is reached.

The timing in which the projector 2 activates the lamp 21 in step S71 and the timing in which the image reproduction device 6 starts the output of the video signal are synchronized with when the control process of the lamps 21 is started in the remote control mode. Accordingly, the computer 1 controls the projectors 2 and the image reproduction device 6 so as to switch and activate the lamps 21, which are activated in accordance with the displayed image.

Finally, the control unit 54 of the projector 2 determines whether or not the lamp 21 that is to be activated next is set in the program list (step S74).

When the lamp 21 that is to be activated next is set, steps S71 to S73 are repeated. This switches the activated lamps 21 at the switching time set in the program list.

In addition to advantages (1), (2), (5), (8), and (9) of the first embodiment, the image display system of the second embodiment has the advantages described below.

(10) The projectors 2 receive a signal indicating the activation period from the computer 1 to set the activation period of each lamp 21. This allows for the activation period of each lamp 21 in the projectors 2 to be remote controlled from the computer 1.

(11) When starting activation of a lamp 21, each projector 2 displays a predetermined image until the illuminance of the lamp 21 stabilizes. After the illuminance of the lamps 21 stabilizes, the displayed image is switched. For example, an image of which purpose is not for advertisement of products and services or for introduction of a facility is displayed until the illuminance of the lamp 21 that started activation stabilizes. After the illuminance of the lamp 21 stabilizes, an image of which purpose is for advertisement of products and services or for introduction of a facility is displayed. Thus, in a state in which the illuminance of the lamp 21 is not stable, commercial purpose video contents are not presented.

(12) The computer 1 controls each projector 2 so as to switch and activate the lamps 21 in accordance with the displayed image. Thus, the activated lamps 21 are switched in accordance with an activation pattern corresponding to the various video contents presented by the projectors 2. This synchronizes the closing of a video content and the switching of the lamps 21. Thus, the switching of the lamps 21 does not interrupt the presentation of the video content.

(13) The computer 1 sets the activation period of each lamp 21 for each activation based on the contents set by the user with the operation unit 14. Further, the computer 1 provides the projectors 2 with a signal indicating activation periods to control the switching of the lamps 21 in the projectors 2. This allows for the switching of the lamps 21 in the projectors 2 to be remote controlled from the computer 1.

(14) Based on the contents set by the user with the operation unit 14, the computer 1 sets the activation pattern of the lamps 21 in the projectors 2 in an activation order and activation period desirable to the user.

(15) Based on the contents set by the user with the operation unit 14, the computer 1 sets the timing for activating the lamps 21 and switches the lamps 21 at the set timings. This generates an activation pattern that switches the activation of the lamps 21 at timings desirable to the user.

(16) The projectors 2 may display images designated by the user in the set activation period.

(17) The computer 1 controls the image reproduction device 6 so as to output a video signal corresponding to the set image during the set activation period. This allows for the plurality of projectors 2 to display the same image by outputting a video signal to the projectors 2 from the image reproduction device 6.

(18) Repeated presentation of a video content is set. When repeating presentation of a video content, reproduction of the set image is repeated during the set activation period. Thus, even when the reproduction of an image ends in the set activation period, the video image may be presented again.

It should be apparent to those skilled in the art that the present invention may be embodied in many other specific forms without departing from the spirit or scope of the invention. Particularly, it should be understood that the present invention may be embodied in the following forms.

In the first embodiment, instead of the time intervals for switching the lamps 21, activation periods of the lamps 21 may be set by timings for switching of the lamps 21. For example, the operation unit 51 of the projector 2 may be used to set the timing for activating the lamps 21. This also allows for the switching of the lamps 21 to be controlled based on the set timing.

Such a structure allows for the activation pattern of the lamps 21 to be set with further flexibility. Further, an activation pattern that activates the lamps 21 at timings desirable to the user may be generated.

In the first embodiment, in the same manner as in the second embodiment, the projector 2 may be configured so that when starting activation of the lamps 21, a predetermined image is displayed until the illuminance of the lamp 21 that started activation stabilizes and so that the displayed image is switched after the illuminance of the lamp 21 stabilizes. Such a structure would obtain advantage (11), which is described above.

In the second embodiment, instead of the timings for switching the lamps 21, time intervals for switching the lamps 21 may be set to set the activation period of the lamps 21.

In the second embodiment, in the same manner as in the first embodiment, at least pat of the activation pattern of the lamps 21 may be set as a repeat pattern. In this case, the control unit 54 switches the lamps 21 in accordance with the repeat pattern. Such a structure would obtain advantage (6), which is described above.

The number of times for repeating the repeat pattern may be set in the same manner as in the first embodiment. In this case, the control unit 54 controls the switching of the lamps 21 so as to repeat the repeat pattern for the required number of times. Such a structure would obtain advantage (7), which is described above.

In each of the above embodiments, the user may selectively set either one of the switching time interval of the lamps 21 and the switching timing of the lamps 21. Such a structure would allow for the activation period of the lamps 21 to be flexibly set. This would improve convenience for the user when setting the activation period.

A prism block, for example, may be used in lieu of the optical path switching device 24 so that the light emitted from the first lamp 21a and the light emitted from the second lamp 21b are both reflected by the prism block and guided to the image generation unit 25. That is, the image generation unit 25 and the projection lens 26 may be shared in the optical paths formed by the plurality of lamps 21. Thus, a device for switching the optical paths is not necessarily required.

Further, the present invention is not restricted to selectively switching a plurality of optical paths formed by the plurality of lamps 21. That is, the present invention is not limited to alternate activation of the lamps 21. As described above, when a prism block is used in lieu of the optical path switching device 24, the plurality of lamps 21 (i.e., the first lamp 21a and the second lamps 21b) may be simultaneously activated. In this case, the lights simultaneously emitted from the lamps 21 are guided to the image generation unit 25. Such a structure would improve the illuminance of the image in comparison to when activating just one lamp 21.

The projector 2 is not limited to just two lamps and may include three or more lamps 21. In this case, as described above, some of the three or more lamps 21 may be simultaneously activated.

The operation unit 51 of the projector 2 may be arranged on a remote controller that corresponds to the projector 2. That is, the projector 2 may include a remote controller, and buttons arranged on the remote controller may form the operation unit 51.

The video signal output unit 13, the control signal input/output unit 16, the video signal input unit 41, the control signal input/output unit 53, and the control signal input/output unit do not necessarily have to be formed by terminals connected to cables or the like and may be formed, for example, by a wireless communication module including an antenna. The input/output means may be either wired or wireless for signals between the computer 1 and the projector 2, the computer 1 and the image reproduction device 6, and the projector 2 and the image reproduction device 6.

The signals input and output between the computer 1 and the projector 2 or between the projector 2 and the image reproduction device 6 are not limited to video signals, and audio signals may be input to the projector 2 together with video signals. In this case, sound may be reproduced with a speaker (not shown), which is an audio output device incorporated in the projector 2. Further, the sound may be reproduced with other audio output devices. In this manner, the present invention is effective not only for digital signage including only video contents but also for digital signage including both video and audio contents.

The present examples and embodiments are to be considered as illustrative and not restrictive, and the invention is not to be limited to the details given herein, but may be modified within the scope and equivalence of the appended claims.

What is claimed is:

1. A video projector comprising:
a plurality of light sources used to display an image; and
a control unit that switches each of the light sources between states of activation and deactivation;
wherein the control unit is capable of setting an activation period for each activation of at least one of the light sources.

2. The video projector according to claim 1, wherein the control unit is capable of setting the activation period for each activation of each of the light sources.

3. The video projector according to claim 1, further comprising:
an operation unit operated by a user, wherein the control unit sets the activation period based on an operation of the operation unit by the user.

4. The video projector according to claim 3, wherein the control unit sets the one of the light sources that is to be activated during the activation period based on the operation of the operation unit by the user.

5. The video projector according to claim 3, wherein the control unit sets an activation timing of each of the light sources based on the operation of the operation unit by the user and switches each of the light sources between the states of activation and deactivation based on the activation timing of each of the light sources.

6. The video projector according to claim 1, further comprising:
a signal input unit that receives a signal indicating the activation period from an external device;
wherein the control unit sets the activation period based on the signal received by the signal input unit.

7. The video projector according to claim 1, further comprising:
a memory that stores information related to the activation period;
wherein the control unit switches each of the light sources between the states of activation and deactivation based on the information stored in the memory.

8. The video projector according to claim 1, wherein the control unit sets an activation pattern, which is used to switch each of the light sources between the states of activation and deactivation, and a repeat pattern, which is used to repeatedly perform at least part of the activation pattern, and the control unit repeats the repeat pattern when performing the activation pattern.

9. The video projector according to claim 8, wherein the control unit sets a number of times to repeat for the repeat pattern, and the repeat pattern is repeated for said number of times when performing the activation pattern.

10. The video projector according to claim 1, wherein the control unit selects either one of an automatic switching mode and a manual switching mode to control the activation and deactivation of the light sources, the control unit switches each of the light sources between the states of activation and deactivation based on the activation period in the automatic switching mode, and the control unit switches each of the light sources between the states of activation and deactivation based on an operation of the user in the manual switching mode.

11. The video projector according to claim 1, wherein the control unit is capable of executing a remote control mode that switches each of the light sources between the states of activation and deactivation based on a signal received from an external device.

12. The video projector according to claim 1, wherein the control unit displays a first image from when at least one of the light sources starts activation to when an illuminance of the light source that started activation stabilizes, and the control unit switches the first image to a second image after the illuminance of the light source stabilizes.

13. A video projector comprising:
a plurality of light sources used to display an image; and
a control unit that switches each of the light sources between states of activation and deactivation, wherein the control unit sets an activation period for each of the light sources in accordance with a reproduction period of the displayed image.

14. An image display system comprising:
a video projector including a plurality of light sources used to project and display an image; and
a controller that controls the video projector so as to switch each of the light sources between states of activation and deactivation in accordance with the displayed image.

15. The image display system according to claim 14, wherein the controller includes an operation unit operable by a user, and the controller sets an activation period for each activation of at least one of the light sources based on an operation of the operation unit by the user; and
the video projector receives a signal indicating the activation period from the controller and switches at least one of the light sources between the states of activation and deactivation based on the signal indicating the activation period.

16. The image display system according to claim 15, wherein the controller sets the one of the light sources that is to be activated during the activation period based on the operation of the operation unit by the user.

17. The image display system according to claim 15, wherein the controller sets an activation timing of each of the light sources based on the operation of the operation unit by the user, and the video projector switches each of the light sources between the states of activation and deactivation based on the activation timing of each of the light sources.

18. The image display system according to claim 14, wherein the controller sets an image displayed by the video projector during the activation period.

19. The image display system according to claim 18, further comprising:
a video signal output device that outputs a video signal to the video projector;
wherein the controller controls the video signal output device so as to output to the video projector the video signal in correspondence with the image during the activation period.

20. The image display system according to claim 18, wherein the controller controls the video projector so as to repeat reproduction of a video content corresponding to the image during the activation period.

21. The image display system according to claim 14, wherein the controller displays a first image from when at least one of the light sources starts activation to when an illuminance of the light source that started activation stabilizes, and the control unit switches the first image to a second image after the illuminance of the light source stabilizes.
